(19) United States
(12) Patent Application Publication
(10) Pub. No.: US 2011/0067513 A1
(43) Pub. Date: Mar. 24, 2011

(54) GEAR BOX ASSEMBLY FOR ROTATING TURRET SYSTEM

(76) Inventor: Ryan Wilson, San Marcos, CA (US)

(21) Appl. No.: 12/566,612

(22) Filed: Sep. 24, 2009

(51) Int. Cl. F16H 1/12

(52) U.S. Cl. 74/416

(57) ABSTRACT

A gear assembly for retrofitting a rotatable turret assembly having pre-existing mounting brackets. A gear assembly housing is cut so that it fits onto the pre-existing housing mounting brackets. An operator controlled hand crank is connected to an input shaft. The input shaft extends through the gear assembly housing and includes an input shaft gear that meshes with a drive shaft gear. The size of the drive shaft gear has been maximized so that it fits within the gear housing that has been mounted on the pre-existing mounting brackets. A drive shaft is connected to the drive shaft gear and extends through the gear housing. A sprocket is connected to the end of the drive shaft gear. The sprocket is mechanically linked to the turret assembly for controlling the rotation of the turret assembly. In a preferred embodiment, the turret assembly is mounted to a HMMWV. Also, in a preferred embodiment the gear housing is fabricated from 6061 billet aluminum and includes cuts to allow for a maximum sized drive shaft gear.

The present invention relates to rotating turret systems, and in particular to gear boxes for rotating turret systems.

### BACKGROUND OF THE INVENTION

FIG. 1 shows the HMMWV M-1114 (also commonly referred to as a Humvee). The HMMWV has seen extensive use by the U.S. Military during the recent wars in Iraq and Afghanistan. The HMMWV is available from AM General, Inc. and can be purchased with varying degrees of armament. For example an unarmored HMMWV is more likely to be used by the military behind the front lines and out of danger of heavy combat. The behind the line vehicles retail for an approximate price of $65,000. A heavily armored HMMWV is built to operate during combat and retails for an approximate price of $400,000.

HMMWV 1 includes rotating turret assembly 2. Rotating turret assembly 2 includes .50 cal machine gun 3. To operate .50 cal machine gun 3, soldier 4 stands up within HMMWV 1 and stands behind armored shield 5 as shown. The soldier can fire machine gun 3 and receive armored protection from the armament of HMMWV 1 and armored shield 5.

During combat and during patrol it is important to be able to have the ability to aim machine gun 3 in a full 360 degree pattern so that the gunner can protect himself and the other soldiers in the HMMWV and nearby. Hence, turret assembly 2 is fully rotatable allowing 360 degree coverage.

FIGS. 2-4 illustrate the prior art method of rotating turret assembly 2. Prior art gears 8 and 18 are housed in prior art gear box 25. Prior art gear box 25 is fabricated from cast aluminum. The soldier manning machine gun 3 is responsible for also rotating the position of turret assembly 2. The soldier controls the position of turret assembly 2 by turning hand crank 7 (FIG. 2). This causes a turning of 2:1 reduction gear 8 and causes turning of sprocket 9. Sprocket 9 is connected via chain 11 to sprocket 10. The turning of sprocket 10 causes turning of sprocket 12. The teeth of sprocket 12 are engaged with the teeth 15 of turret 2. Hence, the rotation of sprocket 12 directly controls the rotation of turret assembly 2.

### Failure of Turret Assembly in the Prior Art

Unfortunately, there is a very high rate of failure of turret assembly 2 during combat and patrol. An armored turret assembly (including armored shield 5) can weigh over 500 pounds. During combat, the soldier operating hand crank 7 turns it quickly to get into the appropriate position. This puts tremendous strain on the teeth of meshing gears 8 and 18. Such a situation is obviously hazardous when, for example, the operator is attempting to maneuver a turret mounted weapon into firing position, especially when HMMWV 1 is on an incline (FIG. 1) that adds additional gravitational forces that must be overcome. Once gear 8 fails, machine gun 3 cannot be rotated and HMMWV 1 becomes extremely vulnerable.

### Test of Prior art Prior Art Gear Box

To test prior art gear box 25 a new prior art gear box 25 was attached to turret assembly 2 as shown in FIG. 2. HMMWV 1 was parked at a 30 degree slant as shown in FIG. 1. Turret assembly 2 was loaded with 400 pounds operational simulated load. A soldier operated hand crank 7 to rotate the turret assembly vigorously as if in a combat situation. After only 3 minutes of turning hand crank 7 prior art gears 8 and 18 failed, thereby rendering turret assembly 2 essentially useless.

What is needed is a better gear box assembly for turret assemblies.

### SUMMARY OF THE INVENTION

The present invention provides a gear assembly for retrofitting a rotatable turret assembly having pre-existing mounting brackets. A gear assembly housing is fabricated so that it fits onto the pre-existing housing mounting brackets. An operator controlled hand crank is connected to an input shaft. The input shaft extends through the gear assembly housing and includes an input shaft gear that meshes with a drive shaft gear. The size of the drive shaft gear has been maximized so that it fits within the gear housing that has been mounted on the pre-existing mounting brackets. A drive shaft is connected to the drive shaft gear and extends through the gear housing. A sprocket is connected to the end of the drive shaft gear. The sprocket is mechanically linked to the turret assembly for controlling the rotation of the turret assembly. In a preferred embodiment, the turret assembly is mounted to a HMMWV. Also, in a preferred embodiment the gear housing is fabricated from 6061 billet aluminum and includes cuts to allow for a maximum sized drive shaft gear.

### BRIEF DESCRIPTION OF THE DRAWINGS

FIG. 1 shows a prior art HMMWV with prior art turret assembly.

FIGS. 2-4 show a prior art gear box assembly.

FIGS. 5-7 show a preferred embodiment of the present invention.

FIG. 8 shows a preferred gear box assembly.

FIG. 9 illustrates the utilization of a preferred embodiment of the present invention.

### DETAILED DESCRIPTION OF THE PREFERRED EMBODIMENTS

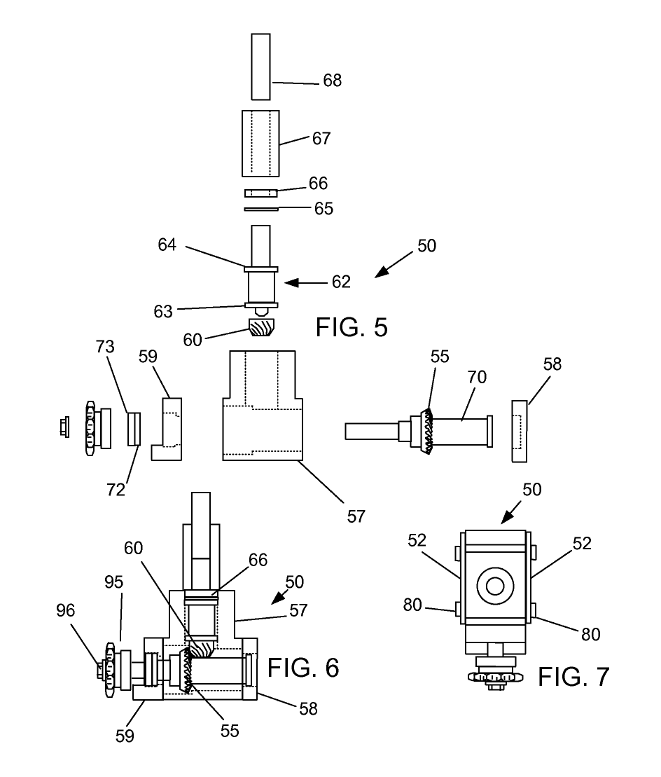

Preferred gear box assembly 50 is shown in FIGS. 5-7. FIG. 5 is an exploded view and FIG. 6 is a side view. FIG. 7 shows a front view of gear box 50 mounted inside prior art mounting brackets 52. Preferred gear box assembly 50 is extremely cost efficient because it is unnecessary to redesign and rebuild turret assembly 2 by modifying or redoing mounting brackets 52. Gear box 50 fits within the space allowed by pre-existing mounting brackets 52. The horizontal distance between mounting brackets 52 is approximately 2⅛ inches.

As explained in the Background section, prior art gears 8 and 18 fail during normal combat usage. To solve the problem of gear failure, the gear box assembly uses larger gears 55 and 60. Housing unit 57, and end caps 58 and 59 are fabricated from high quality aircraft grade 6061 billet aluminum. Also, the utilization of end caps 58 and 59 allows for gear box assembly 50 to be easily taken apart for routine maintenance.

### Components of the Preferred Embodiment

### Drive Gear

Drive gear 55 is a spiral bevel gear. In the prior art gear box, drive gear 8 suffers failure primarily because of its size. It is therefore the goal of the present invention to make drive gear 55 as large as possible within the confines set up by mounting brackets 52. In a preferred embodiment of the present invention drive gear 55 is approximately 1.86 inches in diameter.

Table 1 summarizes a preferred drive gear 55:

TABLE 1

| Gear Type | Spiral Bevel Gear |
|---|---|
| Number of Teeth | 26/13 |
| Pitch Diameter | 1.86/.93 |
| Face | .31 |
| Bore | .750/.4375 |
| Mounting Distance | 1.188/1.250 |
| Hub Diameter | 1.38/.81 |

### Input Gear

Input gear 60 meshes with drive gear. Input gear 60 is attached to input shaft 62.

### Input Shaft

Input shaft 62 is supported by bearings 63 and 64. Bearings 63 and 64 are separated by approximately 1.5 inches to allow for optimum support. The distance of 1.5 inches reduces torsional stress on input shaft 62. Snap ring 65 helps hold bearing 64 in place and seal 66 seals housing 57.

### Coupler and Adapter

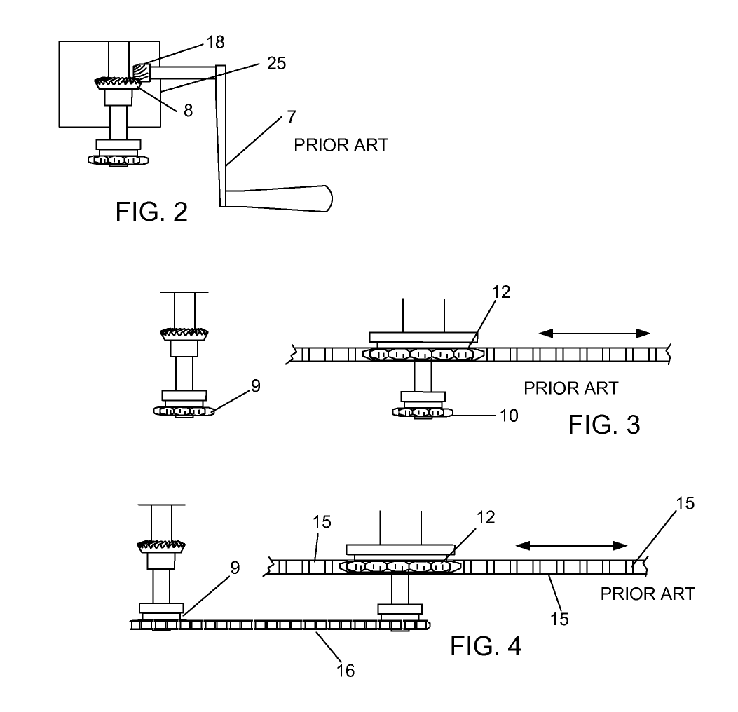

Coupler 67 and adapter 68 fit on input shaft 62. Adapter 68 attaches to prior art crank 7 (FIG. 2) to receive rotational input from the soldier operator.

### Drive Shaft

Drive shaft 70 extends through housing 57 and is supported by bearings 71 and 72. Bearing 71 fits into end cap 58 and bearing 72 fits into end cap 59. Seal 73 is adjacent bearing 72 and seals drive shaft 70 within housing 57. Drive gear 55 is connected to drive shaft 57 as shown.

### Gear Housing and End Caps

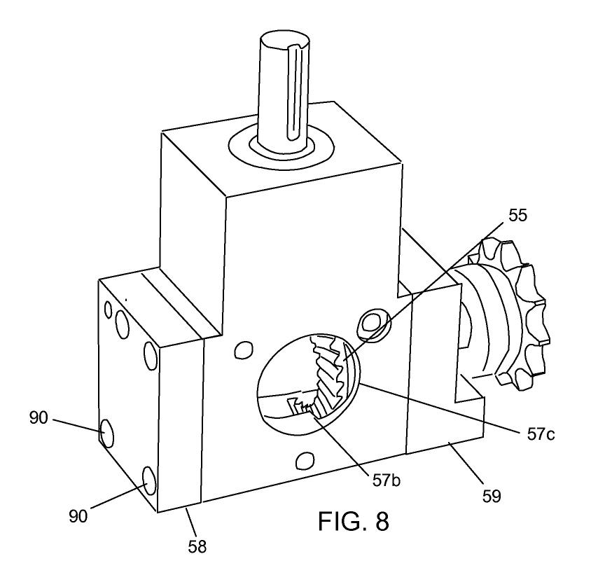

Gear housing 57 and end caps 58 and 59 are all fabricated from 6061 billet aluminum. 6061 billet aluminum provides the optimum balance of hardness and strength to reduce unnecessarily torsional stress and wear on the gears. End caps 58 and 59 are both bolted to gear housing 57 (FIG. 8). Maintenance and repair can be easily performed on any of the components by merely removing end caps 58 and 59 to have access. This is in contrast to prior art gear box 25 which does not have end caps and cannot be taken apart without damaging the gear box. A failure of prior art gear box 25 requires a replacement of the entire gear box.

It should also be noted that the utilization of 6061 billet aluminum allows the utilization of very large drive gears. For example, FIG. 8 shows a gear housing 57 with a cut-out view to see drive gear 55. Housing 57 has been cut at 57b to allow for drive gear 55 to extend almost to the edge of mounting bracket 52 (FIG. 7). For example, 6061 billet aluminum is cut so that it is approximately ⅛ inch thick at 57c (near the location of drive gear 55). This allows for a maximum size drive gear 55.

### Drive Sprocket

Drive sprocket 95 is connected to the end of drive shaft 70. Drive sprocket 95 is further held in place by utilization of bolt and washer 96.

### Utilization of Preferred Embodiment

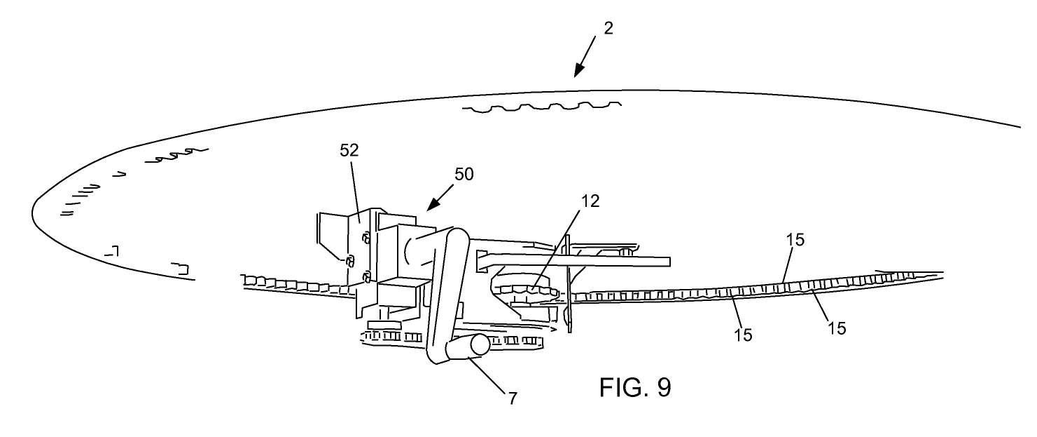

FIG. 9 shows a perspective view of a preferred embodiment of the present invention utilized in turret assembly 2. Gear box assembly 50 is easily bolted into pre-existing mounting brackets 52. The soldier operator turns hand crank 7 to cause sprocket 12 engage teeth 15 to rotate turret assembly 2.

### Test of Preferred Embodiment

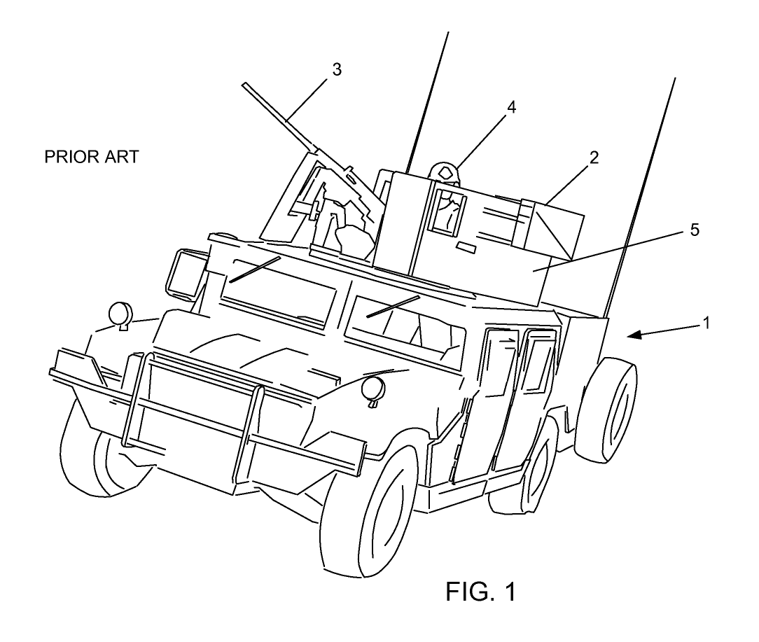

To test the preferred embodiment, gear box assembly 50 was attached to turret assembly 2 as shown in FIG. 9. HMMWV 1 was parked at a 30 degree slant as shown in FIG. 1. Turret assembly 2 was loaded with 400 pounds operational simulated load. A soldier operated hand crank 7 to rotate the turret assembly vigorously as if in a combat situation. After fifteen minutes of rigorous rotation, there was no failure. The operation load was then increased to 700 pounds. Again, after fifteen minutes of rigorous rotation, there was still no failure.

In the preferred embodiment described above, gear box assembly 50 has a load rating of 148 inch-pounds. This is a 100% increase in strength over prior art gear box 25.

### Other Features of the Preferred Embodiment

A significant advantage of gear box assembly 50 is that it is very easy to repair existing HMMWV's currently in operation. There is no need to replace the entire turret assembly, only the gear box assemblies need replacement. Also, drive gear 55 is larger and will last much longer than the prior art drive gear. Finally, when it is determined that it is appropriate to replace drive gear 55, it can be replaced easily by removing end caps 58 and 59 as discussed above. Drive gear 55 can be inspected and replaced if necessary, without having to replace the entire gear box assembly 50.

### Other Applications of Improved Gear Box Assembly The above discussion focused on the utilization of gear box assembly 50 for a HMMWV. However, it should be noted that other turret systems on other military vehicles could also utilize the improved gear box assembly discussed above. For example, there are other MATV (Multipurpose All Terrain Vehicles) that have a rotating turret assembly with confined or pre-existing mounting brackets. For example, the MRAP (Mine Resistant Ambush Protected) vehicle includes a rotating turret assembly with pre-existing mounting brackets. Gear Assembly 50 could be configured to fit within the mounting brackets while simultaneously maximizing the size of drive gear 55.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1) A gear assembly for retrofitting a rotatable turret assembly having pre-existing gear housing mounting brackets, comprising:
A) gear assembly housing fittable within said pre-existing housing mounts and mounted to said pre-existing gear housing mounting brackets,
B) an input shaft extending into said gear assembly housing,
C) a operator controlled hand crank connected to said input shaft,
D) an input shaft gear connected to said input shaft,
E) a drive shaft gear meshed with said input shaft gear, wherein the size of said drive shaft gear has been maximized for increased gear strength and maximized so that it is fittable within said gear assembly housing,
F) a drive shaft connected to said drive shaft gear and extending through said gear assembly housing, and
G) a sprocket connected to the end of said drive shaft gear, said sprocket mechanically linked to said turret assembly for rotating said rotatable turret assembly.

2) The gear assembly as in claim 1, further comprising at least two bearings spaced on said input shaft at maximum distance to support said input shaft and reduce torsional stress to said input shaft.

3) The gear assembly as in claim 1, comprising at least one removable end cap rigidly connected to said gear housing, wherein maintenance or replacement of components within said gear housing is performed by removing said at least one end cap.

4) The gear assembly as in claim 1, wherein said gear assembly housing is fabricated from 6061 billet aluminum.

5) The gear assembly as in claim 4, wherein said gear assembly housing includes cuts to allow for the maximization of the size of said drive shaft gear.

6) The gear assembly as in claim 1, wherein said rotatable turret assembly is attached to a MATV.

7) The gear assembly as in claim 1, wherein said rotatable turret assembly is attached to HMMWV.

8) The gear assembly as in claim 1, wherein said rotatable turret assembly is attached to a MRAP.

9) A gear assembly for retrofitting a rotatable turret assembly on a HMMWV having pre-existing gear housing mounting brackets, comprising:
A) gear assembly housing fittable within said pre-existing housing mounts and mounted to said pre-existing gear housing mounting brackets,
B) an input shaft extending into said gear assembly housing,
C) a operator controlled hand crank connected to said input shaft,
D) at least two input shaft bearings spaced on said input shaft at maximum distance to support said input shaft and reduce torsional stress to said input shaft.
E) an input shaft gear connected to said input shaft,
F) a drive shaft gear meshed with said input shaft gear, wherein the size of said drive shaft gear has been maximized to fit within said pre-existing gear housing mounting brackets,
G) a drive shaft connected to said drive shaft gear and extending through said gear assembly housing,
H) at least two bearings spaced on said drive shaft at maximum distance to support said input shaft and reduce torsional stress to said drive shaft, and
I) a sprocket connected to the end of said drive shaft gear, said sprocket mechanically linked to said turret assembly for rotating said rotatable turret assembly.

10) The gear assembly as in claim 9, further comprising a drive shaft bolt and washer connected adjacent said sprocket and for securing said sprocket to said drive shaft.
